(19) United States
(12) Patent Application Publication
(10) Pub. No.: US 2003/0158991 A1
(43) Pub. Date: Aug. 21, 2003

(54) Transceiver circuitry for sending and detecting OOB signals on serial ATA buses

(76) Inventors: Klaus-Peter Deyring, Scotts Valley, CA (US); James Rubino, Santa Cruz, CA (US); Scott Richmond, Boulder, CO (US)

Correspondence Address: RONALD CRAIG FISH, RONALD CRAIG FISH, A LAW CORP., POST OFFICE BOX 2258, MORGAN HILL, CA, 95037, US

(21) Appl. No.: 10/061,631

(22) Filed: Feb. 1, 2002

(51) Int. Cl. G06F 13/14

(52) U.S. Cl. 710/305

(57) ABSTRACT

A transmitter for transmitting an OOB signal in a serial ATA bus comprising a conventional Fiber Channel transmitter modified to have output coupling capacitors with values selected to cause transition to a common mode voltage condition on the serial ATA bus within the time specified in the serial ATA bus specification when an illegal pattern of all logic 1 or all logic 0s is loaded into the input shift register of said transmitter. Also disclosed is a OOB signal pattern receiver comprising a conventional Fiber Channel receiver which cannot go into a powered down mode and having OOB signal pattern recognition circuitry coupled to the output shift register of the receiver. Also disclosed is a OOB signal pattern receiver comprising a conventional Fiber Channel receiver which can go into a powered down mode and having OOB signal pattern recognition circuitry coupled to the inputs of said receiver.

### FIELD OF USE

The invention is useful in the ATA serial bus protocol or any other serial bus protocol wherein the bus can lose synchronization or goes into sleep mode and needs to be re-established for active serial data communication. Currently, many disk drives in desktop personal computers and laptops are connected to a parallel format ATA bus. The parallel cable is a ribbon cable with a host of individual wires bound into a plastic insulator so as to be flat and wide. The wide nature of the cable interfered with cooling airflow inside the computer, which gets to be a significant problem as the switching rates of the circuitry rise with the ever-increasing clock speed.

Further, the parallel wires cause parasitic capacitances between the wires, which sap away energy in the high frequency Fourier components of high-speed, digital data signals being driven on the lines. This tends to round off the corners of step function digital transitions and alter the rise time of these signals. This limits the application of such a bus for extremely high clock rate traffic to and from the disk drive. There are many other problems with the parallel ATA buses inside computers such as echoes caused by the lack of termination, the possibility that connectors can be plugged in upside down, etc.

There is an ever-present need to drive data to and from disks at ever-higher rates, so a movement arose to convert from the parallel ATA bus configuration to a serial bus configuration. This created a need for a whole new set of serial communication protocols capable of bi-directional digital data transfer at very high rates. A coalition of companies was formed to develop the protocols. Each company is allowed to patent the innovations they developed to solve various ones of the problems that needed to be solved for creation of the new standard. If an innovation was adopted by the group, it would be placed in the specification for the new standard. The specification for the standard was developed by the group under non-disclosure agreements signed by each member of the group.

One of the problems that needed to be solved was how to signal the transceivers at each end of the bus that reset processing (the so-called OOB interval) needed to start when anything went wrong with the transfers of data over the bus such as loss of synchronization. The OOB interval is an interval on the bus when processing is performed to calibrate the bus, achieve synchronization and do other things that are not relevant to the invention. The invention described herein only has to do with circuitry used transmit an OOB signal to indicate the need for OOB processing and for recognition of the OOB signal.

Serial data transfer normally involves use of a transmit clock which is encoded in the data which is transmitted. The transmit clock is not transmitted on a separate line. In serial ATA, the serial bus only has three lines in each direction, two for a differential signal, and one ground line and there is no separate clock line. This requires that the receiving transceiver recover the clock used by the transmitter to send the data. Usually this is done with a phase lock loop which tracks the embedded clock signal and keeps a local oscillator synchronized to the embedded clock. This phase lock loops has to keep the receiving transceiver clock in synchronization with the transmit clock for the bus to work properly. Because constant synchronization must be maintained, the transmitters must constantly transmit data with an embedded clock signal even when they have no data to send. Thus, fill data which is meaningless is transmitted when there is no data to send.

When something goes wrong with this process, the receiving transceiver has lost synchronization and cannot receive any data. When this happens, a reset process must be performed to fix whatever problem has occurred and get both sending and receiving transceivers back into synchronization with each other. This reset process is called an OOB interval in serial ATA bus protocol parlance.

In portable computers, battery life is limited, so there is a need to put the hard drive and the serial ATA bus into sleep mode during periods of inactivity to conserve battery life. When this happens, the serial ATA bus must be reawakened, calibrated and synchronization must be achieved again. This is achieved in a serial ATA bus by performing an OOB process.

The need for OOB reset processing must be signalled by the transmission of some unique signal which cannot be mistaken for real data and can be recognized.

The problem solved by the invention is how to transmit and how to recognize this unique OOB signal. The OOB signal is sent to all transceivers coupled to a serial ATA bus and clearly indicates that the bus is “broken” and the reset processing of an OOB interval needs to start.

The assignee of the invention devised an OOB signal and protocol. This innovation was adopted by the group developing the serial ATA bus standard and is described in a U.S. patent application entitled SIGNALLING PROTOCOL FOR SIGNALLING START OF RESET PROCESSING IN SERIAL ATA BUS PROTOCOL, filed ______, Ser. No. ______, which is hereby incorporated by reference. This signalling process is referred to in the serial ATA bus standard as part of the OOB protocol.

Another big problem that needed to be solved was the fact that the unique signal that signals the start of an OOB interval needs to be detected by circuitry that is inexpensive and does not consume large amounts of power. Frequently the OOB signal is sent to awaken the bus from sleep mode in laptop computers. Laptops, like desktop computers, will be using serial ATA buses between their motherboards and their hard drives when the standard is adopted. These laptops are power limited because of the limited capacity of their batteries. To conserve power, the laptop disk drives and displays are powered down after a predetermined period of nonuse to conserve battery power. In conventional serial communications at high speeds, the serial data transmitters have to transmit data at all times even if it is only fill data so that the receiver can recover the transmit clock from the transmit data itself and stay in synchronization. This is a problem for laptops since to keep the high power transceivers transmitting fill data during the sleep interval uses up the battery. A way to put the disk drives to sleep, shut off the high power transceivers and then monitor for a wake up signal using a low power receiver was needed for the serial ATA standard.

Further, since consumers often make judgments on which personal computers to buy based upon price alone, it is important that whatever circuitry is used to monitor for the OOB signal be inexpensive. This problem of how to make the circuit inexpensive could be solved by using standard, off-the-shelf Fiber Channel transceiver parts but for the fact that standard Fiber Channel transceiver integrated circuits are incapable of driving a differential pair of signal lines to common mode (essentially zero difference in voltage between the signal lines) since common mode never occurs in standard Fiber Channel serial communications. The problem is that the OOB signal involves periods of common mode or silence, and off-the-shelf Fiber Channel transceivers are incapable of driving a differential serial data transmission pair to common mode.

In other words, the OOB signal relies upon the fact that a common mode or silent interval is a very unusual event in a serial ATA bus. Therefore, the OOB signal signals the need for an OOB reset interval by including at least one common mode interval of a duration known to all transceivers on the bus followed by a burst of any data. Because standard Fiber Channel transceivers are incapable of driving a differential serial data pair to common mode, they are, without modification, incapable of being used to generate the OOB signal.

Further, standard off-the-shelf Fiber Channel transceiver receiver sections are high power devices which cannot be used practically to monitor for the OOB signal during sleep mode in laptop computers. This is because the high power consumption would dissipate the battery leaving nothing left for operation upon awakening from sleep mode. High power Fiber Channel transceivers can be used, adapted or modified to receive the OOB signal when the bus is broken or to monitor for the OOB signal in sleep mode in desktop machines where power is plentiful, and such a usage, adaptation or modification is within the scope of the invention.

Therefore, a need has arisen for a circuit to monitor for the OOB signal which is inexpensive and, preferably, low power, and for a usage and modification or adaptation of standard Fiber Channel transceiver transmitter sections to enable standard parts to be used to send the new OOB signal. There has also arisen a need for a method of using, adapting or modifying a standard high power Fiber Channel transmitter section to receive the OOB signal either when the bus is broken or to monitor for the OOB signal during sleep mode for use in desktop machines.

### SUMMARY OF THE INVENTION

In the preferred embodiment, the circuitry to generate the OOB signal using a standard Fiber Channel transceiver transmitter section includes a pair of capacitors having a predetermined value which are in series with each output line of a differential pair at the output of a standard fiber channel transmitter. These capacitors are normally present in conventional Fiber Channel medium driver circuits. However, their values have been altered from the prior art value to cause decay from a logic 1 or high level in a differential signalling scheme down to the common mode voltage level to occur over a predetermined interval. This interval is established by the values of the capacitors to be within the tolerances specified in the serial ATA specification for the maximum interval over which the driver output which is transmitting the OOB signal may transition from transmission of conventional 8b/10b encoded data down to or up to the common mode level, as the case may be. This transition from whatever signal level each differential driver output during transmission of data to the common mode level is necessary to start a space or silent interval of a predetermined duration. This “space” or silent interval is part of the OOB signaling protocol. The values of the capacitors in series with the output driver lines are selected in light of the known termination resistance that terminates the differential pair so as to meet the ATA specification for “decay time”, i.e., the time to enter the common mode voltage condition at the onset of a silent interval in OOB signal generation.

To use this modified structure to generate an OOB signal, it is also necessary to load an illegal data pattern into a parallel-in, serial-out shift register which exists at the input of a conventional Fiber Channel transceiver. Specifically, to generate each common mode or silent interval, the conventional 10-bit parallel in, serial output register coupled to the input of a conventional fiber channel transmitter which has been modified by the addition of the two capacitors is loaded with all logic 0s or all logic 1s for the predetermined duration of the silent interval. The all logic 1 or all logic 0 pattern of bits loaded into the shift register causes the conventional fiber channel transmitter chip to lock its output lines so that one stays at the differential signalling fiber channel high level and the other stays at the conventional fiber channel differential signalling low level. A pattern of all 0s causes one of the lines to go high and the other to go low, whereas a pattern of all 1s causes the other line to go high and the first to go low. Because the series capacitors do not pass DC, the voltage on the output side of the capacitors initially instantly transitions to whatever voltage each output line assumed caused by the all logic 1 or all logic 0 data pattern, but then decays toward common mode. The RC time constant of the decay is established by the value of the capacitors at the transmitter outputs and the known value of the termination resistance at the other end of the line.

The OOB signal pattern can be received using conventional Fiber Channel transceivers modified to recognize the OOB signal pattern. The OOB signal pattern can also be received by use of a conventional high power Fiber Channel transceiver receiver section having its output register coupled to a separate, low power circuit that recognizes the OOB pattern. This low power circuit may be either external to the conventional high power transceiver but coupled to its output shift register or it may be implemented internally on the same integrated circuit die as the high power Fiber Channel transceiver.

The process of the invention for detecting transmission of an OOB reset signal comprises:

receiving and buffering data transmitted on the serial data bus using a serial data receiver such as a Fiber Channel receiver and an output register;

analyzing data stored in the register to determine if it contains a predetermined illegal pattern of data that would never occur in real data;

if the data in the register contains an illegal pattern of data, comparing the illegal pattern of data to an illegal pattern of data that defines the OOB reset signal, and, if there is a match, activating a signal indicating that an OOB reset signal has been received.

The above defined generic process can be applied to detecting the illegal pattern of an OOB signal on a serial ATA bus in the following manner. First, a conventional Fiber Channel receiver circuitry having its output coupled to load a serial-in, parallel-out shift register is used to receive whatever data is transmitted on the bus and load it into the shift register. The output shift register is coupled to either an external or internal low power circuitry designed specifically to monitor for the OOB signal pattern by analyzing the data in the output shift register. Specifically, to detect the OOB signal using standard Fiber Channel receivers only requires monitoring of the output serial-in, parallel-out shift register for an illegal all logic 0 or an all logic 1 pattern. This illegal pattern will be present in the output shift register when an OOB space is being received. Fiber Channel differential receivers have hysteresis. This means that when one input is high and the other input is low, and the two inputs transition to their opposite states, the output does not transition immediately when the two input signals pass the midway point between the high and low levels. The voltages have to go past the midway point before the output will transition. In any event, when the input lines both go to a common mode voltage level, the output from a standard Fiber Channel receiver will be unpredictable, but it is known that the output will be either all logic 1s or all logic 0s and this is the data that will be loaded into the output shift register. Thus, to detect the OOB common mode intervals only requires monitoring the output data from the serial-in, parallel-out shift register for an all logic 0 or an all logic 1 pattern and measure the interval(s) over which this pattern persists and compare the duration of each interval to the predefined common mode interval or predefined pattern of common mode intervals that comprise the OOB signal. In the preferred embodiment, that predefined pattern would be three consecutive common mode intervals, each of 320 nsec duration and separated by bursts of any data.

In the preferred embodiment, the circuitry which monitors the data in the output data register for the OOB pattern is implemented in all CMOS so as to consume very little power during sleep mode. However, many serial ATA buses will be put into desktop machines where power consumption is not as serious of a concern. The reception of the OOB signal can also be accomplished using the conventional high power transceiver by simply adding pattern recognition circuitry of either a high power or low power nature at any point therein such that a common mode input voltage condition can be recognized, timed and subjected to pattern analysis. The pattern analysis functions to determine if the duration of each common mode interval is the predetermined duration of the OOB signal and the predetermined pattern of said common mode intervals in the OOB signal definition exists.

### BRIEF DESCRIPTION OF THE DRAWINGS

FIG. 1 is a block diagram of a circuit for generating an OOB signal using a conventional Fiber Channel transmitter which has been modified for this purpose.

FIG. 2 is a timing diagram of the OOB signal pattern specified in the serial ATA bus specification for an OOB signal to initialize or reset a serial ATA bus which has lost synchronization or is otherwise not working properly.

FIG. 3 is a timing diagram of the OOB signal pattern specified in the serial ATA bus specification for an OOB signal to wake a serial ATA bus which has been in sleep mode.

FIG. 4 is a series of timing diagrams that show the voltages that occur on the output differential pair of a Fiber Channel medium driver circuit in front of the capacitors and behind the capacitors upon transition from loading conventional 8b/10b encoded data into the input register and loading all logic 1s or all logic 0s to implement a silent interval of an OOB signal.

FIG. 5 is a block diagram of an OOB receiver using a conventional high power Fiber Channel receiver with an output register coupled to a low power OOB pattern recognition circuit for monitoring for the OOB signal in both bus active and sleep modes but wherein the receiver can never go into sleep mode and power down.

FIG. 6 is a block diagram of a OOB receiver using a conventional high power Fiber Channel receiver which can go into sleep mode and power down and having low power OOB pattern recognition circuitry coupled to the input of the receiver.

### DETAILED DESCRIPTION OF THE PREFERRED AND ALTERNATIVE EMBODIMENTS

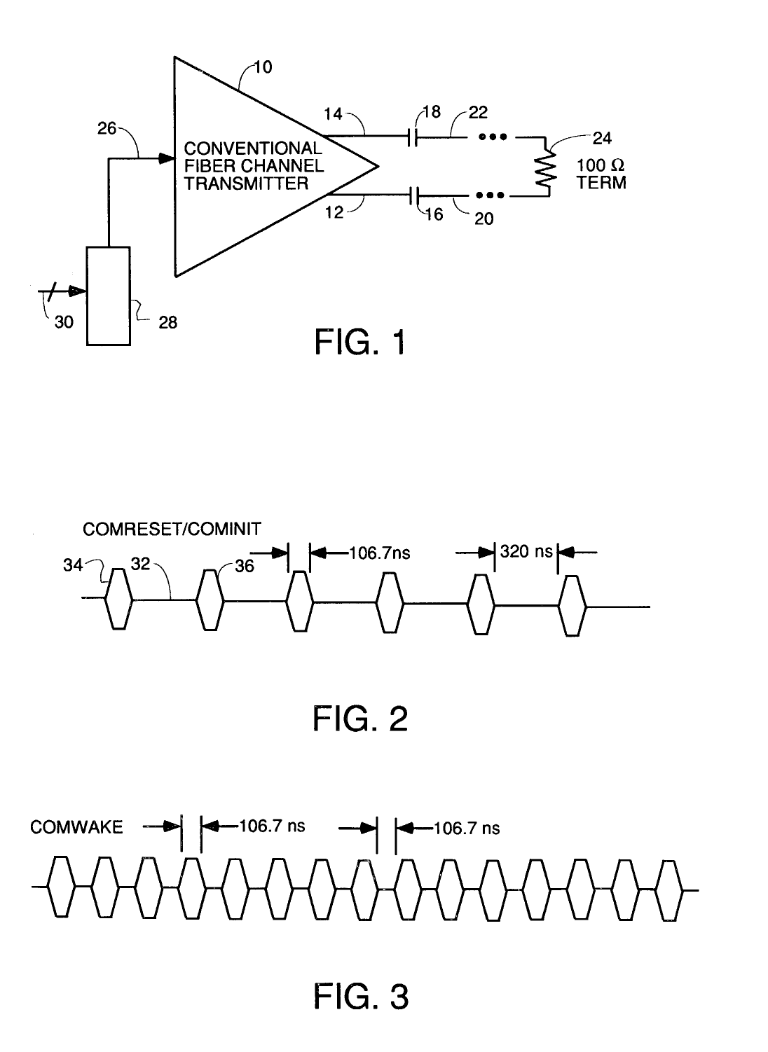

Referring to FIG. 1, there is shown a block diagram of a circuit for generating an OOB signal using a conventional Fiber Channel transmitter which has been modified for this purpose. The conventional Fiber Channel transmitter 10 has differential outputs 12 and 14. Each of these outputs has a series capacitor 16 and 18 coupling the output to a corresponding one of two transmission mediums 20 and 22. These two transmission lines for a differential pair that carries normal 8b/10b encoded data when the bus is operating correctly and carries the OOB signal whenever it is transmitted. The two transmission lines 20 and 22 are coupled at the opposite end of the bus to a receiver (not shown) which has a 100 ohm resistor 24 coupled across the two lines for termination purposes. The serial data input 26 is coupled to the serial data output of a parallel-in, serial-out shift register 28. The silent intervals of predetermined duration of an OOB signal are generated by using parallel bus 30 to load all logic 1s or all logic 0s into register 28 for such a time that the interval over which these bits are shifted out is equal to the predetermined duration of the silent interval needed for the OOB signal.

FIG. 2 is a diagram of the OOB signal used to start an OOB reset interval for the situation where a reset because of loss of synchronization, etc. has occurred. FIG. 3 is a diagram of the OOB signal used to start an OOB reset interval to wake up an ATA bus from sleep mode. In FIG. 2, the interval 32 between data bursts 34 and 36 represents a common mode or silent interval such as never occurs naturally in any serial bus protocol where the clock is transmitted with the transmitted data. In all such protocols, the transmission medium is never quiet since even if the transmitters have no payload data to send, they still send fill data which has the transmit clock encoded therein so that phase lock loops in the receiver can stay locked onto the clock. In the serial ATA bus protocol, the silent intervals have a duration of 320 nanoseconds, and three consecutive silent intervals of this duration separated by data bursts of any data and any length comprise the OOB signal. When this pattern is detected, a signal must be generated which signals the software to do the series of processes that together comprise the OOB interval.

Thus, in FIG. 1, to generate a common mode interval having the duration of 320 nanoseconds, an appropriate number of all logic 1s or all logic 0s are loaded into the shift register 28 to cause the lines 12 and 14 to assume a steady state voltage differential for the required common mode interval. If, for example, all logic 1s are loaded, this causes line 14 to go high and line 12 to go low for as long as the transmitter is receiving all logic 1s. The converse would be true with line 12 high and line 14 low for all logic 0s. Either condition causes lines 20 and 22 to both decay in voltage from the voltage they assume when the logic 1s start arriving down toward the common mode voltage. Eventually, depending upon the RC time constant established by the value of the capacitors 16 and 18, the resistance 24 and effective R and C values of the transmission lines 20 and 22, line 20 and 22 both reach common mode voltage. This happens because the capacitors 16 and 18 do not pass DC, so the voltages on lines 22 and 20 decays toward the common mode voltage approximately midway between the high and low voltages on lines 14 and 12. This common mode voltage condition persists for as long as logic 1s are being loaded into register 28 (or logic 0s).

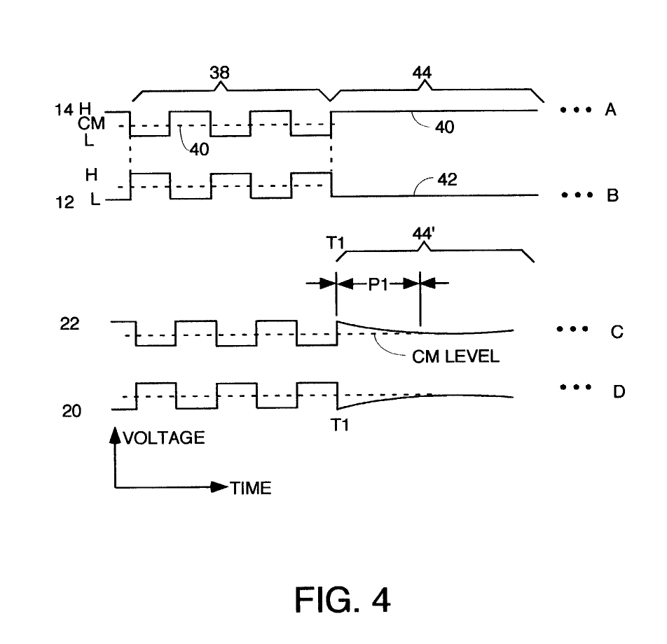

FIG. 4, comprised of time lines A through D, shows the voltages on lines 14, 12, 22 and 20, respectively during times when 8b/10 data is being sent and then when a predetermined interval of all logic 1s or all logic 0s are loaded into register 28. Interval 38 represents the interval during which conventional 8b/10b encoded data is being loaded into register 28. The voltage transitions on time lines A and B show the resulting voltage transitions on lines 14 and 12, respectively, during interval 38. Note that both lines transition as a differential pair between high and low voltages marked H and L. These high and low voltages bracket a common mode voltage CM represented by dashed line 40. In other words, lines 14 and 12 are equal and opposite mirror images of each other, i.e., when line 14 goes high, line 12 simultaneously goes low. The 8b/10b pattern is selected such that the average voltage on each of lines 14 and 12 is zero so that there is no DC component to the signal on either line. Therefore, the capacitors 16 and 18 stay charged at the common mode level. Now at time T1, a system wide reset signal occurs indicating something has gone wrong and the serial ATA bus (or other serial format data bus) needs to have OOB processing during an OOB reset interval to re-establish communications on the bus. At this time, all logic 1s or all logic 0s are sent into shift register 28 in FIG. 1. This causes line 14 in FIG. 1 to go high, as shown at 40 in FIG. 4, and causes line 12 to go low, as shown at 42. An instantaneous change in the voltage on lines 22 and 20 to go high and low, respectively, also occurs across capacitors 16 and 18 because the voltage across a capacitor cannot be changed instanteously. However, because the logic 1s and logic 0s are loaded into register 28 continuously for the duration of the common mode interval to be generated as part of the OOB signal, lines 14 and 12 stay high and low, respectively, for the entire interval 44. This causes current to flow through both capacitors 16 and 18 and the 100 ohm termination resistor 24 temporarily thereby altering the charge on the capacitors until the voltage conditions equilibrate and there is no potential difference between the voltages on lines 22 and 20. This causes the decay of voltage on lines 22 and 20 illustrated during interval 44′ (the same interval as interval 44 but concerning the voltage on lines 22 and 20). This causes the voltage on each of lines 22 and 20 to equilibrate down to common mode level over the interval P1. The maximum duration of interval P1 is defined in the serial ATA specification. The values of capacitors 16 and 18 are altered from their prior art values so that, considering the termination resistance of 100 ohms, the RC time constant is such that the voltage on each of lines 22 and 20 reaches a voltage of within 50 millivolts of the common mode voltage within the interval P1. The silent or common mode interval that forms part of the OOB signal pattern is considered to begin when both lines 22 and 20 drop to within 50 millivolts of common mode. The pattern of all logic 1s or all logic 0s is maintained for an interval long enough to create the predefined duration for the common mode or silent interval. Then any data is loaded into register 28 to transmit the burst of any data that signals the end of the silent interval. In the particular OOB signal defined in the serial ATA specification, this pattern of silent intervals of a predetermined duration followed by a burst of data is repeated three times to complete the OOB signal pattern.

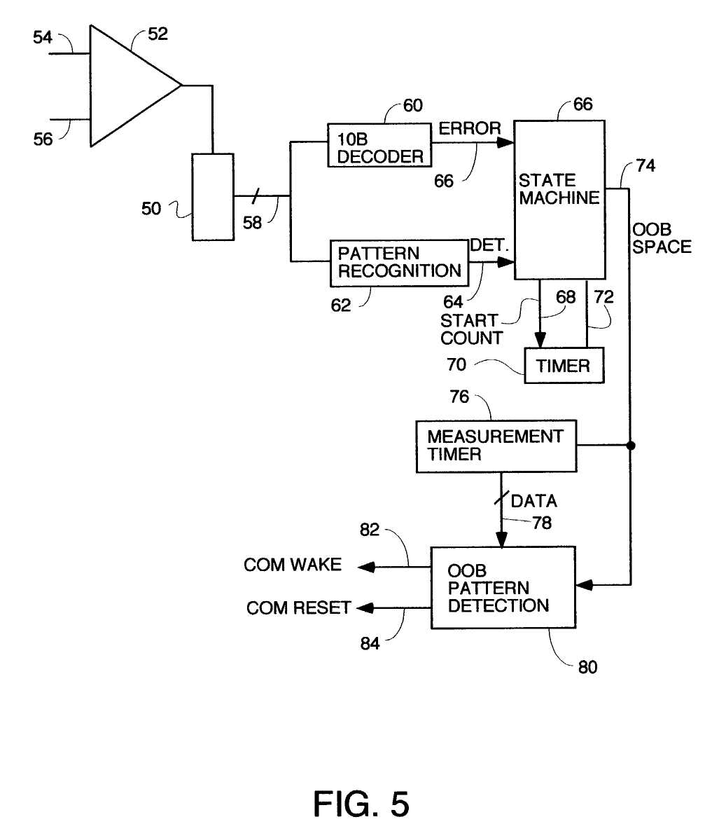

Referring to FIG. 5, there is shown a conventional Fiber Channel receiver to which has been added additional pattern recognition circuitry to monitor the output data pattern to detect the presence of an OOB pattern. Preferably, the pattern recognition circuitry is implemented in CMOS so as to have low power consumption when monitoring for the OOB signal when the serial ATA bus 54, 56 is in sleep mode. However, the pattern recognition circuitry can also be high power technology, and it may be implemented external to the conventional Fiber Channel receiver 52 or integrated on the same die therewith or at least in the same integrated circuit package if on a separate die. In other words, if a process to integrate high power, fast current mode logic transistors for the Fiber Channel as well as low power CMOS devices on the same integrated circuit die does not exist, two separate dies made by different processes optimized for current mode logic such as Emitter Coupled Logic and CMOS, respectively, can be used to make two different dies, and the two dies may be mechanically supported, enclosed and connected to the outside world by the same integrated circuit package.

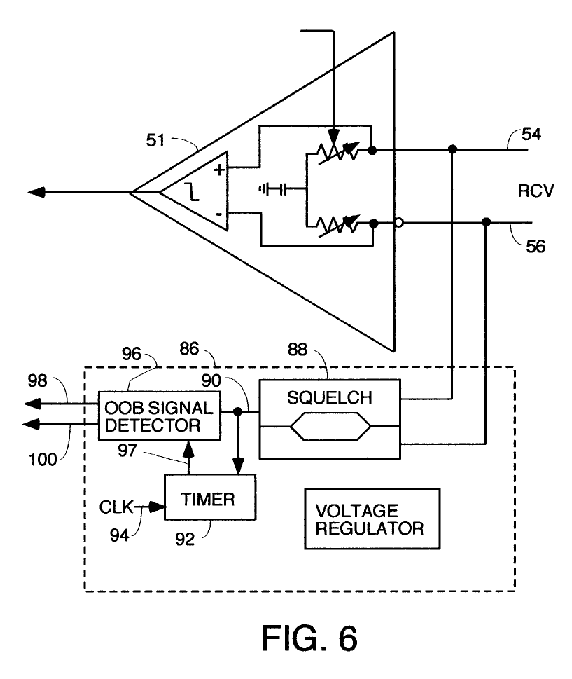

Detection of an OOB signal using conventional Fiber Channel receivers involves monitoring the data content of a serial-in, parallel-out register 50 coupled to the output of a conventional Fiber Channel receiver 52 and processing the data therein to recognize an OOB pattern. The pattern recognition circuitry is all the circuitry in FIG. 5 other than the receiver 52 and the shift register 50. This pattern recognition circuitry monitors the data in output register 50 at all times when the bus is active and at all time when the bus is in sleep mode. To do this however, the high power receiver 52 can never go to sleep when the bus 52 and 54 is in sleep mode. In alternative embodiments, the pattern recognition circuitry is coupled directly to the input lines 54 and 56 and is modified to detect common mode voltage conditions on lines 54 and 56 and time them and then to compare the duration of each common mode interval and the pattern of common mode intervals to a predetermined pattern of common mode intervals that define the OOB signal. Such a circuit is shown in FIG. 6.

In some embodiments, the receiver may have a parallel output data format, and register 50 is a parallel-load, parallel-output register. A standard Fiber Channel receiver is used for serial ATA bus applications, but for other serial bus types where the teachings of the invention are applied, other differential or single ended data receivers could be used so long as the bus protocol requires constant transmission of data or fill characters at all times to keep clocks in sync such that an OOB pattern consisting of one or more silences can be easily recognized.

In the preferred embodiment, the Fiber Channel receiver 52 is coupled to two differential receive data lines 54 and 56, and is unmodified from its conventional design. In other embodiments with other type serial buses that do not use differential signalling, a single ended receiver may be used. The receiver 52 has a serial output coupled to the serial data input of a serial-in, parallel-out shift register 50. The parallel output 58 of shift register 50 is coupled to the input of a 10B decoder 60 and a pattern recognition circuit 62. The 10B decoder examines the output data on bus 58 for illegal 10B patterns. The pattern recognition circuit 62 can be part of the 10B decoder, but, for convenience here, is shown separately. The pattern recognition circuit 62 functions to recognize, for an OOB signal, an all logic 1 pattern or an all logic 0 pattern on bus 58.

It is known that when an OOB space is being received, a pattern of all logic 1s or all logic 0s will be present in the output register 50. Fiber Channel differential receivers have hysteresis. This means that when one input is high and the other input is low, and the two inputs transition to their opposite states, the output does not transition immediately when the two input signals pass the midway point between the high and low levels. The voltages have to go past the midway point before the output will transition. In any event, when the input lines both go to a common mode voltage level, the output from a standard Fiber Channel receiver will be unpredictable, but it is known that the output will be either all logic 1s or all logic 0s and this is the data that will be loaded into the output shift register. Thus, to detect the OOB common mode intervals only requires monitoring the output data from the serial-in, parallel-out shift register for an all logic 0 or an all logic 1 pattern and measure the interval(s) over which this pattern persists and compare the duration of each interval to the predefined common mode interval or predefined pattern of common mode intervals that comprise the OOB signal. In the preferred embodiment, that predefined pattern would be three consecutive common mode intervals, each of 320 nsec duration and separated by bursts of any data.

In other embodiments on serial buses where a signal like the OOB signal is used, the OOB signal may be comprised of some other illegal and easily detectable data pattern other than one or more intervals of silence or common mode. In such other embodiments, the pattern recognition circuit 62 serves to recognize whatever illegal data pattern is used to signal the start of a reset processing interval or to wake the bus from sleep. When such a pattern is detected in either a serial ATA bus or some other serial bus protocol, a DETECT signal on line 64 goes active. Since an all logic 1 or all logic 0 pattern on bus 58 is an illegal pattern, 10B detector would detect this fact and activate an ERROR signal on line 64.

A state machine 66 functions to examine the signals on line 64 and 66 and determine when a possible OOB space or silent interval may be starting. The signals on lines 66 and 64 will change states erratically when normal data is being received. However, when a legitimate OOB space is being received, the signals 66 and 64 settle down to steady state values for the duration of the OOB space. The purpose of the state machine 66 is to examine the signals on lines 66 and 64 and make a determination of when an OOB space may be starting. It does this by activating a START COUNT signal on line 68 when the signals on lines 64 and 66 enter the state they would be in if a legitimate OOB space were being received (both true or logic 1). This causes a timer 70 to start counting. The timer 70 is a time out timer which is designed to activate the signal on line 72 when it times out a predetermined time after the signal on line 68 is activated. That predetermined time is set to be long enough to be sure that the existence of a simultaneous true state for both signals on lines 64 and 66 is not an accident and may mean that an OOB signal is starting. When the timer 70 times out and the signal on line 72 goes active, if the signals on lines 64 and 66 are both still true, state machine 66 activates the OOB SPACE signal on line 74. The state machine keeps the OOB SPACE signal on line 74 active from the time timer 70 times out and the signals on lines 64 and 66 are still true to the time when one or both of the signals on lines 64 and 66 go false. In the claims, this interval is referred to as a “predetermined time”, and it may or may not be equal to the duration of an OOB space interval. In effect, the combination of state machine 66 and timer 70 “debounce” the signals on lines 66 and 64 to determine when a true OOB space is starting.

If the state machine 66 concludes that an OOB interval may have started, it activates an OOB SPACE signal on line 74. Activation of the signal on line 74 does not necessarily mean that an OOB signal has started, but all legitimate OOB signals will cause the activation of the OOB SPACE signal on line 74. Further measurements must be made before a conclusion may be drawn that an OOB signal has occurred. The signal on line 74 is made active at the time said timer 72 times out and the signals on lines 64 and 66 are still true. The signal on line 74 is deactivated when either of the signals on line 66 or 64 goes false.

Activation of the signal on line 74 causes a measurement timer 76 to start counting. When the signals on lines 66 and 64 are no longer in the state they are in during an OOB space (both true), the OOB space has ended, and state machine 66 detects that fact and deactivates the signal on line 74. This causes the measurement timer 76 to stop counting. The count data of counter 76 is output on bus 78 to a pattern recognition circuit 80.

The pattern recognition circuit examines the count data on bus 78 and uses it to determine the length of each OOB space and the sequence in which OOB spaces occurred if more than one OOB space is the defined sequence for the OOB signal. The OOB pattern detector must be programmed in advance with configuration data that defines the number of OOB spaces and the durations of those spaces and the sequence of those durations so that the OOB pattern can be recognized. Once an OOB pattern has been recognized, the pattern detector activates the appropriate output line. In embodiment of FIG. 5, two different OOB patterns are used, one to wake up the bus from sleep mode (COM WAKE) and the other to reset the bus when something has gone wrong (COM RESET). A COM WAKE signal on line 82 is activated when the COM WAKE OOB pattern has been detected. A COM RESET signal on line 84 is activated when the COM RESET pattern has been detected.

To use the circuitry of FIG. 5 to detect an OOB pattern requires that power be applied at all times to the Fiber Channel receiver 52 and all the circuitry in FIG. 5 coupled to the output of receiver 52. However, the circuit of FIG. 5 has the advantage that it can be quickly and cheaply implemented using a standard Fiber Channel receiver off the shelf with addition of some simple additional logic thereby drastically reducing the development time.

In alternative embodiments, high power, fast pattern recognition circuitry may be incorporated into the circuitry of the Fiber Channel receiver 52 to detect the OOB pattern. The pattern recognition circuitry in this embodiment can take any form that is capable of detecting the OOB pattern. It is added at any point in the Fiber Channel receiver such that a common mode input voltage condition can be recognized, timed and subjected to pattern analysis. The pattern analysis functions to determine if the duration of each common mode interval is the predetermined duration of the OOB signal and the predetermined pattern of said common mode intervals in the OOB signal definition exists. Many such designs to do the pattern recognition process just described will be apparent to those skilled in the art, and the particular circuitry chosen and architecture chosen is not critical to the invention.

FIG. 6 is a block diagram of a OOB receiver using a conventional high power Fiber Channel receiver which can go into sleep mode and power down and having low power OOB pattern recognition circuitry coupled to the input of the receiver. A conventional Fiber Channel or other receiver 51 monitors the bus 54 and 56 and receives high speed data transmitted thereon. Contrary to receiver 52 in FIG. 5, receiver 51 is of a type which can power down in sleep mode. The bus 55 and 56 can be differential mode or a singled ended bus in which case receiver 51 is singled ended. The invention is applicable to any serial format data bus wherein data or fill data needs to be transmitted at all times and wherein there is a need to send a reset signal when synchronization is lost or when the bus needs to be awakened from sleep.

A low power receiver 86 has its inputs coupled to lines 54 and 56 in parallel with the connections of the inputs of high power receiver 51. This allows the high power receiver to be turned off to conserve energy when the serial ATA bus and the motherboard, disk driver other circuitry of the computer is powered down during sleep mode while the low power receiver continues to monitor the bus for the OOB chirp during sleep. This is an important feature especially in laptop computers which have limited battery life. A conventional squelch circuit 88 determines when the signals on lines 54 and 56 are in common mode, i.e., within 50 millivolts of each other, thereby indicating a common mode signal or “space” is being received. When the signals on lines 54 and 56 are within a predetermined voltage range from each other, squelch circuit 88 sets its output signal on line 90 to logic 1. In a single ended receiver, squelch circuit 88 could be a simple comparator which compares the voltage on the single receive data line to a ground reference. The signal on line 90 returns to logic zero when the common mode silent interval ends and any data is being transmitted on lines 54 and 56. During normal differential, serial data transmissions, lines 54 and 56 are swinging back in forth in voltage at all times to differential signal levels that encode the high speed 8b/10b encoded data, and even if the bus has lost synchronization, the voltages on lines 54 and 56 are never common mode. Thus, when lines 54 and 56 are driven to common mode, this fact is very easy to detect since it is very unusual.

A timer/counter 92 counts clock cycles of a clock signal which is either generated internally or received on line 94 (either will suffice and there is no need for both). Counting starts when the signal on line 90 transitions to logic 1 and counting stops when the signal on line 90 transitions to logic 0. It is important to correct operation of the invention and the expense of the low power receiver that the tolerances on the durations of the silent intervals in the OOB chirp and the “over” signal at the end of the chirp be lenient enough that the timer 92 does not have to be a precision timer so that it can still be used with adequate accuracy to measure the duration of the silent intervals.

An OOB signal detector 96 also receives the signal on line 90 and has a data input 98 coupled to read the count in counter/timer 92. The OOB signal detector is typically a state machine which reads the count in counter 92 at each transition of the signal on line 90 and compares the count at the beginning of each silent interval to the count at the end of each silent interval. From this data, the duration of each silent interval can be deduced since the clock period is known. The OOB signal detector 96 then compares the duration of the one or more silent intervals and the pattern of the silent intervals, if more than one silent interval is used, to the known duration(s) and pattern of durations of the common mode interval(s) of an OOB or other reset signal to draw a conclusion as to whether an OOB or other reset pattern has been received.

In the preferred embodiment, when the pattern of FIG. 2 is received, OOB signal detector 96 sets the signal on output line 98 to logic 1 and when the pattern of FIG. 3 is received, the output signal on line 100 is set to logic 1. The signals on lines 98 and 100 are held in a logic 1 state for as long as the OOB pattern is being sent on the bus.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

what is claimed is:

1. A receiver for monitoring a serial ATA bus for the occurrence of an OOB signal, comprising:
a conventional Fiber Channel differential receiver having a parallel output;
a 10B decoder coupled to said parallel output and having an output at which a first signal appears which is set active by said 10B decoder when an illegal 10B pattern occurs in said shift register;
a pattern recognition circuit coupled to said parallel output and having an output at which a second signal appears which is set active by said pattern recognition circuit when a pattern of all logic 1s or all logic 0s appears in said register;
a state machine coupled to said first and second signals, for determining when said first and second signal have both been true for a predetermined amount of time and activating a third signal and for deactivating said third signal when either or both of said first and second signals go false;
a measurement timer for measuring the interval(s) during which said third signal is active; and
a pattern recognition circuit coupled to said measurement timer for analyzing the pattern of states of said third signal and the duration(s) of at least one of said states, and for drawing a conclusion as to whether an OOB signal has or has not occurred, and, if an OOB signal has occurred, for activating a fourth signal.

2. A process for detecting the transmission of an OOB signal on a serial ATA bus, comprising:
using a conventional Fiber Channel receiver to receive data on said bus;
analyzing said received data to determine if it contains an illegal 10B pattern, and, if so, activating a first signal;
analyzing said received data to determine if it contains a predetermined pattern of bits, and, if so, activating a second signal;
determining if said first and second signals are both active for more than a predetermined amount of time, and, if so, activating a third signal and keeping said third signal active as long as both said first and second signals are active; and
analyzing the duration(s) and pattern of the interval(s) when said third signal are active to determine if an OOB signal pattern is present.

3. A receiver apparatus to detect the presence of an predetermined signal pattern on a serial data bus, comprising:
a conventional differential or single ended receiver having its input(s) coupled to a bus upon which data or fill characters are normally constantly transmitted so as to maintain synchronization, said receiver having a parallel output at which received data appears;
a first decoder means for examining the data in said parallel output of said receiver and determining when said data represents an illegal pattern for normal data transmission of said bus and for outputting a first signal which is active when an illegal pattern has been detected;
a second decoder means for examining the data in said output register and determining when said data is a predetermined pattern such as all logic 1s or all logic 0s and for outputting a second signal which is active when said predetermined pattern is present;
means coupled to receive said first and second signals, for detecting when said first and second signals are both active for a time sufficiently long to be assured that the activation of both said signals is not an accident and may mean that said predetermined signal pattern is possibly starting, and for activating a third signal for a predetermined time; and
means coupled to said third signal for measuring the duration of predetermined states thereof and analyzing the pattern of said predetermined states and drawing a conclusion as to whether said predetermined signal pattern has occurred on said serial data bus or not, and, if so, for activating a fourth signal.

4. A process for determining if a reset signal comprised of a predetermined pattern of illegal common mode data transmissions have been transmitted on a serial format, differential signal data bus, comprising:
receiving data transmitted on said data bus using a conventional differential signal input receiver;
using high power pattern recognition circuitry which has been added to said conventional receiver at a point to be able to recognize illegal common mode input signals on said differential signal data bus and to time the duration of said common mode intervals;
using said high power pattern recognition circuitry to analyze the duration of each said common mode interval and the pattern of said common mode intervals and compare said pattern to a predetermine pattern of common mode intervals that defines said reset signal.

5. A receiver apparatus to receive high speed data transmitted on a bus and monitor for a bus reset signal comprised of any bit pattern or voltage condition on said bus which is illegal and never occurs during real data transmissions, comprising:
a high speed conventional receiver having one or more inputs coupled to said bus to receive high speed data transmitted on said bus, said receiver being capable of being powered down in sleep mode;
a low power pattern detection means coupled to said one or more inputs of said receiver for monitoring at all times for the occurrence on said bus of said bit pattern or voltage condition on said bus which is illegal and never occurs during real data transmissions, and upon detection thereof, for activating a signal which indicates a reset signal has been received.

6. A transmitter for transmitting an OOB signal on a differential serial ATA bus, comprising:
a conventional Fiber Channel transmitter having a parallel-in, serial-out input shift register coupled to its input and having first and second differential outputs;
a first capacitor coupled to said first differential output for coupling said first differential output to a first transmit line on a differential serial ATA bus;
a second capacitor coupled to said second differential output for coupling said second differential output to a second transmit line on a differential serial ATA bus;
and wherein the values of said first and second capacitors are different from the coupling capacitors of a conventional Fiber Channel transmitter and have values selected in light of the termination resistance which terminates said differential serial ATA bus so as to establish an RC time constant which causes a decay on each transmit line from a differential signalling voltage level to a common mode voltage level within a predetermined time whenever an illegal data pattern of all logic 0s or all logic 1s is loaded into said input shift register.

7. A method for transmitting an OOB signal on a serial ATA differential signalling bus, comprising:
1) loading an illegal data pattern comprising all logic 1s or all logic 0s into an input shift register of a conventional fiber channel transmitter and continuing to load said illegal data pattern into said shift register for an interval equal to the duration of a first common mode interval of a OOB signal on a serial ATA bus;
2) loading any legal data pattern into said input shift register at the conclusion of step 1;
3) loading an illegal data pattern comprising all logic 1s or all logic 0s into an input shift register of a conventional fiber channel transmitter and continuing to load said illegal data pattern into said shift register for an interval equal to the duration of a second common mode interval of a OOB signal on a serial ATA bus;
4) loading any legal data pattern into said input shift register at the conclusion of step 3;
5) loading an illegal data pattern comprising all logic 1s or all logic 0s into an input shift register of a conventional fiber channel transmitter and continuing to load said illegal data pattern into said shift register for an interval equal to the duration of a third common mode interval of a OOB signal on a serial ATA bus; and
6) loading any legal data pattern into said input shift register at the conclusion of step 5.
